(19) United States
(12) Patent Application Publication
(10) Pub. No.: US 2007/0157250 A1
(43) Pub. Date: Jul. 5, 2007

(54) Method and apparatus for recording using multiple program schedule data sources to modify recording schedule

(75) Inventor: Steven Morris, Taipei (TW)

Correspondence Address: BACON & THOMAS, PLLC, 625 SLATERS LANE, FOURTH FLOOR, ALEXANDRIA, VA, 22314, US

(73) Assignee: Arcadyan Technology Corporation, Hsinchu (TW)

(21) Appl. No.: 11/325,375

(22) Filed: Jan. 5, 2006

(51) Int. Cl. G06F 13/00; H04N 5/445; G06F 3/00

(52) U.S. Cl. 725/58; 725/39; 725/61

(57) ABSTRACT

A method and apparatus for recording according to a recording schedule for a processing unit. (a) Service information including schedule information for a current show and a next show to be provided in a digital broadcast stream is acquired. (b) A determination is made as to whether there is a difference, in terms of the current and the next shows, between the schedule information included in the acquired service information and a program schedule database, such as an EPG database. (c) A determination is made as to whether at least one of the current show and the next show is scheduled to be recorded according to the recording schedule. (d) If so in step (b) and step (c), the recording schedule is modified according to the difference in step (b). (e) The processing unit is controlled according to the difference in step (b) and the modified recording schedule.

### BACKGROUND OF THE INVENTION

1. Field of the Invention

The invention relates in general to recording shows with a video recorder according to a recording schedule, and more particularly to recording digital television programs with a video recorder according to a recording schedule, with multiple program schedule data sources to make the recording more accurate.

2. Description of the Related Art

Many personal video recorder (PVR) systems today use include an electronic program guide (EPG) to make it easier for users to record programs. These EPGs use a database containing program schedule information to display TV listings to the user and to provide more information about specific shows when the user requests it. The information contained within this database is gathered by a third party company that specializes in this, and the database is then sold or licensed to a PVR manufacturer for use in their products.

In PVRs for analog TV systems, updates to this EPG database are usually downloaded from the service provider, either over a modem or over an existing network connection. Typically, the PVR will download new EPG data once per day, usually in the middle of the night, to reduce the costs of telephone calls and the inconvenience of using the telephone.

Digital TV systems may include schedule information in the broadcast as part of the service information (SI) contained in every digital TV stream, but broadcasters are often reluctant to include complete schedule information because of bandwidth constraints. Schedule information is usually limited only to the current and following shows (the mandatory minimum in most SI standards). This makes it useless for EPG purposes, and so many PVR systems on digital networks still download an EPG database.

Recording programs in a PVR is conventionally according to a recording schedule, which is typically set by a user of the PVR, with reference to an EPG database. Although the downloaded database of program schedules offers a number of advantages in terms of the amount of data that can be provided, it suffers from one important limitation—the timeliness of the data. Broadcasters may change their schedules on short notice, either because of a major news event pre-empting existing programming or because of an event overrunning. For example, a sports match goes in to overtime and the network continues coverage. There is also a smaller risk that broadcasters may change their schedules without the EPG data provider being aware of this. In these cases, the PVR would inefficiently record programs that users do not want, thus wasting storage space of a PVR.

Since the schedule information may be up to one day old, the receiver has no way of knowing about these changes. The result of this is that the user may see an inaccurate representation of the program schedule, and that shows may not be recorded correctly due to these schedule changes. While technologies such as Program Delivery Control (PDC) can be used to improve this situation be informing the receiver when a specific show is about to start, this is not useful when a show has been cancelled or when a major change in the schedule has taken place. This can mean that the PVR may sometimes record the wrong show, due to changes in the schedule that the unit can not detect.

Thus, it is desirable to provide a method for use in a video recorder to provide effective and efficient program recording functionality that accurately meet user requirements for recording, for example, with respect to accurate timing and contents.

### SUMMARY OF THE INVENTION

It is therefore an object of the invention to provide a method and an apparatus of recording according to a recording schedule and multiple program schedule data sources. Comparison among the multiple data sources and the recording schedule is made in order to detect schedule changes with respect to a digital broadcasting service. Different actions can be made in response to these changes so that the method may be adaptable to various situations.

The invention satisfies the above-described object by providing a method for recording according to a recording schedule for a processing unit. The method includes the following steps. (a) Service information included in the digital broadcast stream is acquired, the service information including schedule information for a current show and a next show to be provided in the digital broadcast stream. (b) A determination is made as to whether there is a difference, in terms of the current and the next shows, between the schedule information included in the acquired service information and a program schedule database including predetermined schedule information with respect to the digital broadcast stream. (c) A determining is made as to whether at least one of the current show and the next show is scheduled to be recorded by the processing unit according to the recording schedule. (d) If it is determined to be so in step (b) and step (c), the recording schedule is modified according to the difference in step (b). (e) The processing unit is controlled according to the difference in step (b) and the modified recording schedule.

The invention satisfies the above-described object by providing an apparatus for recording according to a recording schedule for program recording. The apparatus is provided with a program schedule database, wherein the program schedule database includes predetermined schedule information with respect to a digital broadcast stream. The apparatus includes a receiver for acquiring service information from the digital broadcast stream, a storage device, and a processor. The receiver is for acquiring service information from the digital broadcast stream, the service information including schedule information for current and next shows to be provided in the digital broadcast stream. The storage device is used for video data storing. In response to difference, in terms of the current and the next shows, between the schedule information included in the received service information and the predetermined schedule information included in the program schedule database, the processor modifies the recording schedule according to the schedule information included in the received service information when at least one of the current show and the next show is scheduled to be recorded according to the recording schedule. The processor controls the apparatus to store video data in the storage device according to the modified recording schedule.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A shows a flowchart illustrating a method for recording according to a recording schedule and multiple program schedule data sources, according to an embodiment of the invention.

FIG. 1B shows a flowchart illustrating how to modify a recording schedule, according to an embodiment of the invention.

FIG. 2 shows an exemplary embodiment of the invention implemented in a personal video recorder.

### DETAILED DESCRIPTION OF THE INVENTION

According to the invention, multiple program schedule data sources are used as a way of checking so that a personal video recorder accurately records shows according to an updated recording schedule resulting from the checking. In one embodiment, when there is a change to the program schedule information for the current and following shows to be provided in a digital broadcast stream, as compared to a program schedule database, such as an EPG database, the recording schedule is modified according to the changes.

According to the invention, the service information is employed as a way of checking the program schedule database, for example, the downloaded EPG database. The schedule information included in the received digital TV stream is more timely and accurate than that contained in the downloaded EPG database. Since the service information is provided by the broadcaster (often automatically), it reflects changes in the actual program schedule that the downloaded EPG data can not.

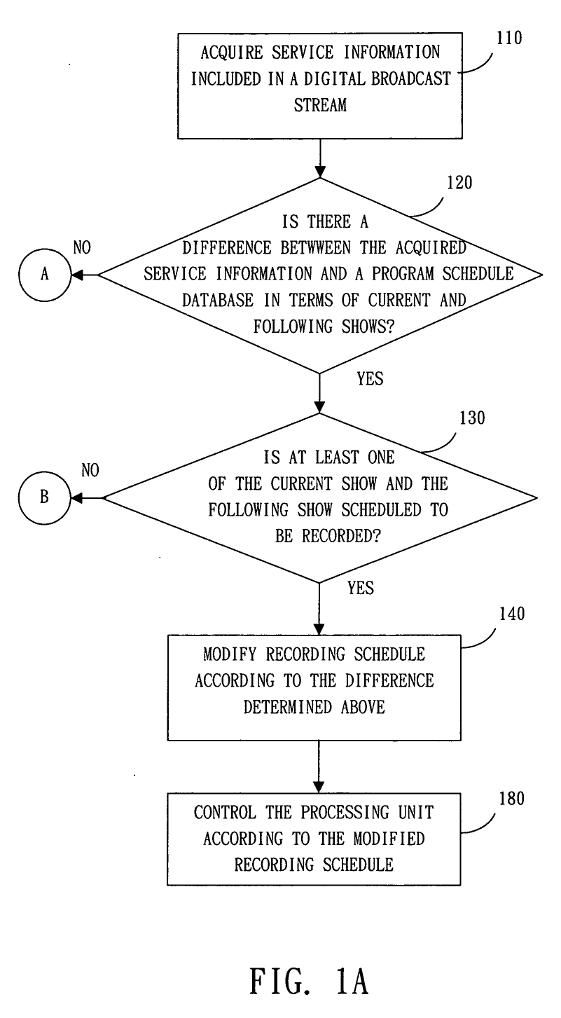

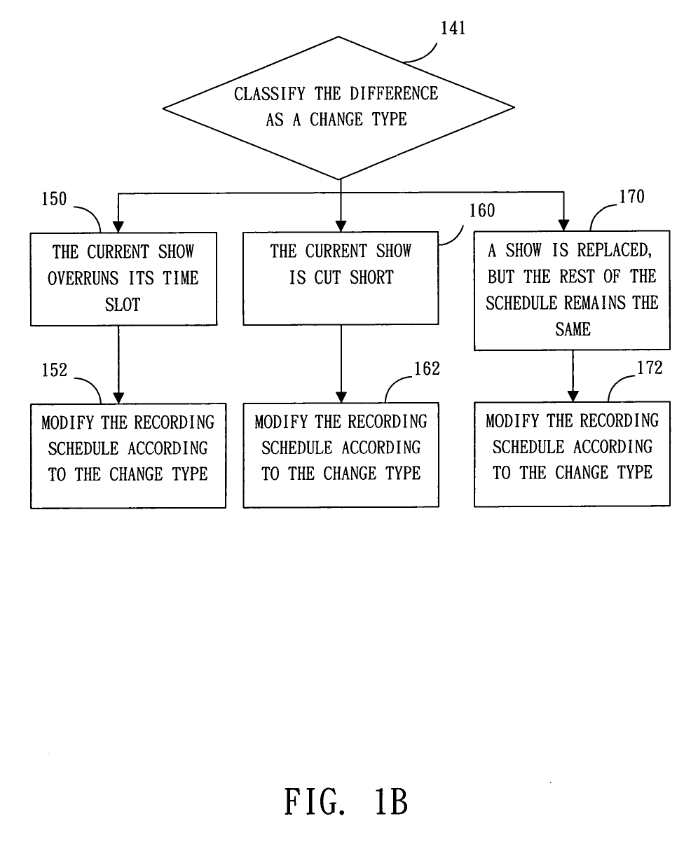

FIG. 1A shows a flowchart illustrating a method for recording according to a recording schedule and multiple program schedule data sources, according to an embodiment of the invention. The method is for use in a processing unit for video recording. The processing unit stores a program schedule database including predetermined schedule information with respect to a digital broadcast stream. For example, the program schedule database can be an EPG database, which can be downloaded by a modem via a telephone line from an EPG provider. Typically, the EPG database is downloaded in the midnight to avoid downloading of the database during daytime because it is a large-sized file.

As shown in FIG. 1A, in step 110, service information included in the digital broadcast stream is acquired by the processing unit, wherein the service information includes schedule information for a current show and a next show to be provided in the digital broadcast stream. The acquired service information is used as a way of checking the program schedule database. In step 120, a determination is made as to whether there is a difference, in terms of the current and the next shows, between the schedule information included in the acquired service information and the predetermined schedule information included in the program schedule database. For example, the processing unit compares the name and start times of the current and next show with that contained in the downloaded database. In step 130, a determination is made as to whether at least one of the current show and the next show is scheduled to be recorded by the processing unit according to the recording schedule. If it is determined to be so in steps 120 and 130, the recording schedule is modified according to the difference in step 120, as indicated in step 140. In step 180, the processing unit is then controlled according to the modified recording schedule.

In step 120, if there is no difference, then the method proceeds to node A. For example, node A indicates that no action is taken since there is no need to modify the recording schedule and no action needs to be taken. In step 130, if it is determined to be so in step 120 but neither the current show nor next show is scheduled to be recorded according to the recording schedule, the method proceeds to node B. For example, node B indicates that no action is taken since there is no need to modify the recording schedule with respect to the current and next shows. Certainly, further refining of the recording schedule may be done in this case for example.

Changes to the schedule indicated by the service information with respect to current and next shows can be detected and classified by comparing the schedule information from the service information with the downloaded program schedule database. If some information is different, then the processing unit, such as a personal video recorder, can use these differences to classify how the actual program schedule has changed and to react according to the classified change. In addition, schedule changes for one show will usually have a knock-on effect on other shows, and so a flag indicating a change in the schedule can be used and keep its value between iterations of this method in one embodiment.

For example, If the schedule information for the current show is not the same as that in the downloaded database, and no change to the schedule has been flagged previously, the processing unit takes the following steps. Next, if a recording for the current show has been scheduled, the following steps are taken. There are two cases under the above conditions concerning the current show. In case 1, if the name of the show has changed, the recording is cancelled and the method attempts to find another showing of the show in the downloaded schedule database. The recording for the next showing (if one exists) is rescheduled. In case 2, if the stop time of the show has changed, the recording is rescheduled so that the recording ends at the new stop time. In each of the cases, the recording schedule is modified and reflects the corresponding actions to be taken. The processing unit then flags that the schedule has changed.

In addition, if the schedule information for the next show is the same as that in the downloaded database, the unit flags that the schedule is not changed.

Further, if the schedule information for the next show is not the same as that in the downloaded database, the processing takes the following steps. Next, if a recording for that show has been scheduled, the following steps are taken. There are two cases under the above conditions concerning the next show. In case 1, if the name of the show has changed, the recording is cancelled and the processing unit attempts to find another showing of the show in the downloaded schedule database. The recording for the next showing (if one exists) is rescheduled. In case 2, if the start and/or stop time of the show has changed, the recording is rescheduled so that the recording starts at the new start time and ends at the new stop time. In each of the cases, the recording schedule is modified and reflects the corresponding actions to be taken. If no change to the schedule has been flagged previously, the processing unit then flags that the schedule has changed.

The method, as illustrated by the above example, can be included in the software within the processing unit that schedules recordings.

More specifically, changes to the schedule indicated by the service information with respect to current and next shows can be classified as a change type. The following embodiment indicates the types of schedule changes that may occur, their wider effects on the schedule, how these changes may be detected, and what actions the processing unit takes. The recording schedule may be modified according to the schedule changes. The processing unit is then controlled to act according to the difference and to perform video recording according to the modified recording schedule. Referring to FIG. 1B, step 140 further includes a step to classify the difference in step 120 as a change type in step 141. In this embodiment, there are three types of changes to the schedule, (1) current show overrunning, (2) current show being cut short, (3) show being replaced but rest of the schedule remaining the same, as indicated in steps 150, 160, and 170, respectively.

In step 150, the change type indicates the current show overruns its time slot. For this type, there are three cases, for example.

In case 1, the schedule change is that following shows are delayed. The difference between SI schedule information and the downloaded schedule database is that start time of next show is later. Delay period is calculated by the difference between start time in the downloaded database and the SI schedule information. Scheduled recordings for any shows in the affected period are delayed by the appropriate amount. If the current show is being recorded, the recording is extended until the start time of the next show.

In case 2, the schedule change is that next show is cancelled and other shows remain as scheduled. The difference between SI schedule information and the downloaded schedule database is that name and start time of next show become that of the following show in the downloaded database. If the next show is scheduled to be recorded, the processing unit attempts to find another showing of that show in the downloaded database. If one is found, the recording is rescheduled. If not, the recording is cancelled. If the current show is being recorded, the recording is extended until the start time of the next show.

In case 3, the schedule change is the next show is replaced and other shows remain as scheduled. The difference between SI schedule information and the downloaded schedule database is that name and start time of next show changes, but following shows remain the same. If the next show is scheduled to be recorded, the processing unit attempts to find another showing of that show in the downloaded database. If one is found, the recording is rescheduled. If not, the recording is cancelled. If the current show is being recorded, the recording is extended until the start time of the next show.

In each case, the recording schedule is modified according to the difference, as indicated in step 152.

In step 160, the change type indicates that the current show is cut short. For this type, there are two cases, for example.

In case 1, the schedule change is that following shows start early. The difference between SI schedule information and the downloaded schedule database is that start time of next show is earlier. The time change is calculated by the difference between start time in the downloaded database and the SI schedule information. Scheduled recordings for any shows in the affected period are moved forward by the appropriate amount. If the current show is being recorded, the recording is stopped at the start time of the next show.

In case 2, the schedule change is that additional show is broadcast. The difference between SI schedule information and the downloaded schedule database is that name and start time of next show changes (start time is earlier) and name and start time of the following show is that of the next show in the downloaded database. If the current show is being recorded, the recording is stopped (it is not rescheduled!! not indicated in the recording schedule!!) at the start time of the next show.

In each case, the recording schedule is modified according to the difference, as indicated in step 162.

In step 170, the change type indicates that a show is replaced, but the rest of the schedule remains the same. For this type, there are two cases, for example.

In case 1, following show remains the same. The difference between SI schedule information and the downloaded schedule database is that name of the next show changes, but following shows remain the same. If the next show is scheduled to be recorded, the unit attempts to find another showing of that show in the downloaded database. If one is found, the recording is rescheduled. If not, the recording is cancelled.

In case 2, following show changes. The difference between SI schedule information and the downloaded schedule database is that name of the next show changes. Name and/or start time of the following show changes.

In each case, the recording schedule is modified according to the difference, as indicated in step 172.

Furthermore, the above embodiments can be refined by the use of the running status of the show. Some digital TV standards, contain more detailed information about the status of a show within the description. This is known as the running status, and may be used to indicate that the start time of a show has been delayed slightly (by a few seconds rather than several minutes) or that what is currently being broadcast is not actually part of the show despite the listings information (e.g. trailers and other promotional material at the beginning of a show will cause the show to start slightly later than its official schedule time). This can make recording even more accurate by helping to distinguish minor delays that do not affect the overall schedule from more serious delays that will cause shows to be rescheduled.

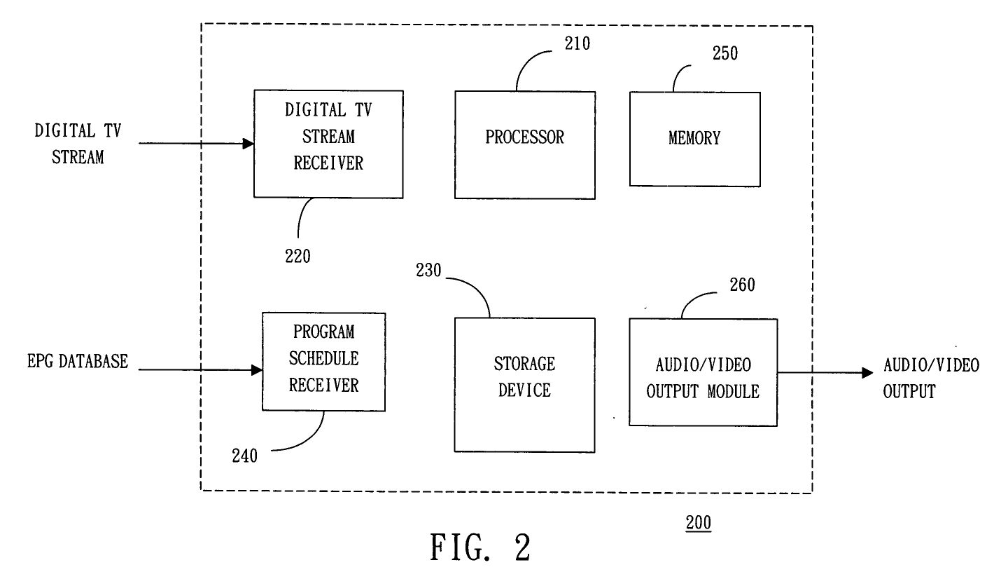

FIG. 2 shows an exemplary embodiment of the invention implemented in a personal video recorder (PVR) 200. The PVR 200 includes a processor 210, a digital TV stream receiver 220, a storage device 230, a program schedule receiver 240, a memory 250, and an audio/video output module 260. The PVR 200 is a processing device for recording video/audio data or digital television shows to the storage device 230 in digital format. In another example, the PVR 200 can also be implemented by a personal computer or a notebook computer executing PVR software that includes instructions implementing the method according to an embodiment of the invention.

The processor 210, such as, a general purpose microprocessor or integrated chipset for specific purpose, controls the PVR 200 to store video data in the storage device 230 according to a recording schedule. The recording schedule, for example, includes data items indicating one or more selected programs that the user wants to record, indicating information, such as starting time, end time, and names of the selected programs. The recording schedule may be user-defined or automatically produced by a PVR according to a user profile. In another example, a user can enter a brief description to the PVR 200 to produce or add scheduled recording in a recording schedule, such as “sports matches in the winter”, without the user manually precisely entering the name and starting times of these shows.

The digital TV stream receiver 220 is employed for receiving the digital TV stream and acquiring service information from the digital TV stream. For example, the digital TV stream can be provided by a digital TV tuner, either an internal or external one. In another example, a data stream parser (not shown) can be implement as a receiver to acquire service information from the digital broadcast stream and this parser can be included in the digital TV stream receiver 220.

In some embodiments, the service information, in different digital television standards, is based on the Program-Specific Information (PSI), in every MPEG-2 transport stream, and is employed to inform the receiver how those services are constructed and what they contain in order to simply program selection. Various digital television standards implement the functionality of the service information. For example, service information in Advanced Television Systems Committee (ATSC) digital TV standards, adopted in North America, is known as program and system information protocol (PSIP), described in document A/65b. Specification for service information in Digital Video Broadcasting (DVB) systems by European Telecommunications Standards Institute (ETSI) is described in standard reference number EN 300 468. Service information for Digital Broadcasting System Standard by the Association of Radio Industries and Businesses (ARIB) of Japan is described in document reference number ARIB STD-B10. Nevertheless, the service information is used as a way of checking a program schedule database, for example, the downloaded EPG database.

The program schedule receiver 240 is used for receiving a program schedule database, such as an EPG database, wherein the program schedule database provides predetermined schedule information including names, starting times, ending times of shows with respect to one or more digital TV streams. For example, the program schedule receiver 240 is a voice modem, either externally or internally equipped in the PVR 200, and is connected to a public switched telephone network in order to download the EPG database from an EPG data provider. In another example, the program schedule receiver 240 can be a network interface, such as a gigabit Ethernet, optical fiber interface, or wireless local area network, for download the program schedule database from a corresponding provider. In one example, the program schedule database can be downloaded from a provider in the Internet.

The memory 250 is a memory buffer, such as SDRAM or flash memory, for temporarily storing data. The method according to the invention, for example, as shown in FIG. 1A, can be implemented as computer-executable instructions in a program, which is loaded into the memory 250 and executed by the processor 210. The program can be stored in an installation disk, a memory card, or a file downloaded from an Internet website, for example.

The audio/video output module 260 converts decompressed audio/video data to a standard audio/video format, which is outputted as audio/video output of the 100 to a display device (not shown).

As disclosed above, the method and apparatus of recording according to the embodiments of the invention can identify schedule changes in advance where possible. In this way, the processing unit, such as a PVR, can reschedule any recordings in such a way as to avoid missing any parts of a show and to record programs that users would like, thus avoiding wasting storage space of a PVR in case of schedule changes. This can be invaluable since updates to schedule information in the service information may be delayed by a few seconds in some cases. A PVR can thus provide effective and efficient program recording functionality that accurately meet user requirements for recording, for example, with respect to accurate timing and contents.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for recording according to a recording schedule for a processing unit, the method comprising:
(a) acquiring service information included in a digital broadcast stream, the service information including schedule information for a current show and a next show to be provided in the digital broadcast stream;
(b) in terms of the current and the next shows, determining whether there is a difference between the schedule information included in the acquired service information and a program schedule database including predetermined schedule information with respect to the digital broadcast stream;
(c) determining whether at least one of the current show and the next show is scheduled to be recorded by the processing unit according to the recording schedule;
(d) modifying the recording schedule according to the difference in step (b) if it is determined to be so in step (b) and step (c); and
(e) controlling the processing unit according to the difference in step (b) and the modified recording schedule.

2. The method according to claim 1, wherein step (d) comprises:
classifying the difference in step (b) as a change type according to the difference in step (b); and
modifying the recording schedule according to the change type.

3. The method according to claim 2, wherein the change type indicates the current show overruns time slot thereof.

4. The method according to claim 2, wherein the change type indicates the current show is cut short.

5. The method according to claim 2, wherein the change type indicates a show is replaced, but the rest of the schedule with respect to the digital broadcast stream remains unchanged.

6. The method according to claim 1, wherein step (e) comprises:
recording the current show from the digital broadcast stream according to the modified recording schedule if the current show is being recorded.

7. The method according to claim 1, wherein step (e) comprises:
recording the next show from the digital broadcast stream according to the rescheduled recording schedule if the next show is scheduled to be recorded.

8. The method according to claim 1, wherein the processing unit is a personal video recorder and the digital broadcast stream is a digital television transport stream.

9. The method according to claim 1, wherein the program schedule database is an electronic program guide.

10. An apparatus for recording according to a recording schedule for program recording, wherein the apparatus is provided with a program schedule database, wherein the program schedule database includes predetermined schedule information with respect to a digital broadcast stream, the apparatus comprising:
a receiver for acquiring service information from the digital broadcast stream, the service information including schedule information for current and next shows to be provided in the digital broadcast stream;
a storage device for video data storing; and
a processor, in response to difference, in terms of the current and the next shows, between the schedule information included in the received service information and the predetermined schedule information included in the program schedule database, for modifying the recording schedule according to the schedule information included in the received service information when the recording schedule schedules storing at least one of the current show and the next show;
wherein the processor controls the apparatus to store video data in the storage device according to the modified recording schedule.

11. The apparatus according to claim 10, wherein the apparatus is a personal video recorder.

12. The apparatus according to claim 10, wherein the apparatus is a personal computer.

13. The apparatus according to claim 10, wherein the digital broadcast stream is a digital television transport stream.

14. The apparatus according to claim 10, wherein the program schedule database is an electronic program guide.

15. A computer-readable medium having computer-executable instructions for perform a method for use in a processing unit for recording according to a recording schedule, the method comprising:
(a) acquiring service information included in a digital broadcast stream, the service information including schedule information for a current show and a next show to be provided in the digital broadcast stream;
(b) in terms of the current and the next shows, determining whether there is a difference between the schedule information included in the acquired service information and a program schedule database, wherein the program schedule database includes predetermined schedule information with respect to the digital broadcast stream;
(c) determining whether at least one of the current show and the next show is scheduled to be recorded by the processing unit according to the recording schedule; and
(d) modifying the recording schedule according to the difference in step (b) if it is determined to be so in step (b) and step (c).

16. The computer-readable medium according to claim 13, wherein step (d) comprises:
classifying the difference in step (b) as a change type according to the difference in step (b); and
modifying the recording schedule according to the change type.

17. The computer-readable medium according to claim 13, wherein the method further comprises:
(e) controlling the processing unit according to the difference in step (b) and the modified recording schedule.

18. A method for use in a personal video recorder for recording according to a recording schedule, the method comprising:
(a) acquiring service information of a digital broadcast stream, the service information including schedule information for latest program information;
(b) in terms of the latest program information, determining how the schedule information included in the acquired service information differs from a program schedule database including predetermined schedule information with respect to the digital broadcast stream;
(c) modifying the recording schedule according to the difference determined in step (b) if the latest program information indicates at least one show that is scheduled to be recorded according to the recording schedule.
